(19) United States
(12) Patent Application Publication
(10) Pub. No.: US 2006/0001978 A1
(43) Pub. Date: Jan. 5, 2006

(54) Optical film capable of absorbing ultraviolet light

(75) Inventors: Tu-Yi Wu, Kaohsiung (TW); Lung-Lin Hsu, Kaohsiung (TW); Yi-Chung Shih, Kaohsiung (TW)

Correspondence Address: LADAS & PARRY, 26 WEST 61ST STREET, NEW YORK, NY, 10023, US

(73) Assignee: ETERNAL CHEMICAL CO., LTD.

(21) Appl. No.: 11/148,932

(22) Filed: Jun. 9, 2005

(30) Foreign Application Priority Data
Jul. 2, 2004 (TW) 093120101

(51) Int. Cl. G02B 11/00

(52) U.S. Cl. 359/642

(57) ABSTRACT

The invention pertains to an optical film comprising a substrate, characterized in that at least one of the surfaces of the substrate has a coating capable of absorbing UV light. The inventive optical film possesses good weatherability and is capable of absorbing UV light.

### TECHNICAL FIELD

The subject invention relates to an optical film comprising a substrate, characterized in that at least one of the surfaces of the substrate has a coating capable of absorbing UV light. The inventive optical film may be applied to glasses or flat panel displays, with good weatherability and the ability of absorbing UV light.

### PRIOR ART

Since the human body may suffer from cataracts, skin cancer, skin burns, and skin thickening if overexposed to UV light, UV light has many adverse effects on the human body.

In addition, if a material is exposed to UV light over a long period of time, it would be damaged and become, for example, yellowed, embrittled, and deformed.

For the purpose of reducing the damages caused by UV light, people have been seeking a powerful and effective UV light absorption material, such as a UV light absorbent. However, the UV light absorbent is an organic material, and has the disadvantages of short service life and high toxicity. To eliminate these disadvantages, nanometer-scale inorganic particles have recently been developed to replace the UV light absorbents.

The imaging of a liquid crystal display (LCD) comprises the following procedure: first projecting a light source from a back light source, passing the light source through a polarizer and then through the liquid crystal molecules, where the angles of the lights penetrating the liquid crystal will be changed by the arrangement of the liquid crystal molecules, and then passing these lights forward through a color filter and another polarizer. Thus, as long as the voltage for exciting the liquid crystal molecules is changed, the intensity and color of the light finally rendered may be controlled, thereby giving different combinations of different shades of colors.

Since the lights emitted by the back light source contain UV light, the polymeric resin in the optical film tends to be yellowed, resulting in a weakened reflection efficacy and the color difference problem associated with LCD.

After a wide range of research, it has been discovered that an optical film with a coating capable of absorbing UV light can absorb most of the UV light from the backlight source without affecting the adhesion of the optical film, and can further provide the optical film with wearability and reduced thickness. By using such optical film, luminance of the LCD may be improved without the need of changing the relevant designs and molds, and thus the disadvantages described above may be obviated effectively.

### SUMMARY OF THE INVENTION

The primary object of the present invention is to provide an optical film comprising a substrate, characterized in that at least one of the surfaces of the substrate has a coating capable of absorbing UV light.

### DETAILED DESCRIPTION OF THE INVENTION

The present invention provides an optical film comprising a substrate, characterized in that at least one of the surfaces of the substrate has a coating capable of absorbing UV light.

The substrate used in the inventive optical film is well known to those skilled in the art without specific limitations, and it may be transparent, translucent or opaque. Generally, the substrate comprises at least one layer of polymeric resin. The polymeric resin layer is not bound to any specific limitation, and may be a layer of, for example, but not limited to, polyolefin resin, such as polyethylene (PE) or polypropylene (PP); polyester resin, such as polyethylene terephthalate (PET); polyacrylate resin, such as polymethyl (meth)acrylate (PMMA); polycarbonate resin; polyurethane resin or a mixture thereof. According to the preferred embodiment of the present invention, the inventive optical film comprises a polyester resin substrate, preferably polyethylene terephthalate. The said substrate may optionally comprise the inorganic material, which is known to those skilled in the art, such as zinc oxide, silicon dioxide, titanium dioxide, alumina, calcium sulfate, barium sulfate, calcium carbonate or a mixture thereof. The substrate used in the invention may be mono-layered or multi-layered wherein one or more of the layers contain(s) such inorganic material. In particular, a three-layered substrate may be used in the present invention, wherein the middle layer contains such inorganic material.

The coating used in the inventive optical film is capable of absorbing UV light, and contains inorganic particulates and a fluoro resin.

The inorganic particulates suitable for use in the inventive optical film are those capable of absorbing UV light without specific limitations, which may be, for example, but are not limited to zinc oxide, silicon dioxide, titanium dioxide, alumina, calcium sulfate, barium sulfate, calcium carbonate or a mixture thereof. The size of the inorganic particulates described above is usually in the range of 1-100 nanometers, preferably 20-50 nanometers.

The amount of the inorganic particulates in the coating according to the invention is 0.01-20%, preferably 1-5% by weight based on the total weight of the coating.

The fluoro resin of the coating used in the present invention is well known to those skilled in the art without specific limitations, and it is preferably a copolymer of a fluoroolefin monomer and an alkyl vinyl ether monomer, more preferably a quaternary copolymer of trifluorochloroethylene.

The fluoroolefin monomers useful for forming the fluoro resin used in the present invention, well known to those skilled in the art, include, for example, but are not limited to chloroethylene, vinylidene fluoride, trifluorochloroethylene, tetrafluorethylene, hexafluoropropylene, or a mixture thereof, preferably trifluorochloroethylene.

The alkyl vinyl ether monomers useful for forming the fluoro resin used in the present invention are not bound to any specific limitations, and may be selected from the group consisting of straight chain alkyl vinyl ether monomers, branched alkyl vinyl ether monomers, cyclic alkyl vinyl ether monomers, and hydroxyl alkyl vinyl ether monomers and mixtures thereof. Preferably, the alkyl in the alkyl vinyl ether has 2 to 11 carbon atoms.

The amount of the fluoro resin in the inventive optical film is 99.99-70%, preferably 99-90% by weight based on the total weight of the coating.

The coating of the inventive optical film may optionally comprise a curing agent, so as to form a crosslink with a binding agent through the chemical bonding between the molecules.

The species of the curing agent suitable for the present invention are well known to those skilled in the art, such as polyisocyanate. The amount of the curing agent in the inventive optical film of the present invention is in the range of 0-20%, preferably 5-10% by weight based on the total weight of the coating.

The inventive optical film may optionally comprise additives well known to those skilled in the art, such as a fluorescent agent or UV light absorbent or a mixture thereof.

The species of the UV light absorbent useful in the coating on the surfaces of the inventive optical film include, for example, benzotriazoles, benzotriazines, benzophenones, and salicylic acid derivatives, which are well known to those skilled in the art.

The fluorescent agent useful in the coating on the surfaces of the inventive optical film is well known to those skilled in the art without specific limitations, and it may be an organic material, including but not limited to benzoxazoles, benzimidazoles, and diphenylethylene bistriazines; or an inorganic material, such as zinc sulfide.

The inventive optical film may be used in the glass for common buildings and cars to provide good UV light resistance. The inventive optical film may also be used as a reflective film for the back light source of a LCD to increase the luminance. Furthermore, the optical film possesses good weatherability and is capable of absorbing UV light, thereby enhancing the efficacy of the LCD.

### EXAMPLES

The following examples are merely for further illustration of the present invention, and are not intended to limit the scope of the present invention. Therefore, various variations and modifications, which may be made by those skilled in the art without departing from the spirit of the present invention, are contemplated by this invention.

### Example 1

Methyl ethyl ketone and toluene, each of 45 g, were added to 126.6 g of a fluoro resin (eterflon 4101, Eternal) (about 60% solids content). The mixture was stirred (at 1000 rpm). Then, 3 g in total of 35 nm zinc oxide/barium sulfate and 18.4 g of a curing agent (desmodur 3390, Bayer) were sequentially added so as to form 250.0 g of a coating material (40% solids content), which was then coated onto a UX-150 (Teijin) substrate. After drying, a 10 μm coating film was obtained. After standing for 7 days, a weathering test was conducted (utilizing the QUV weathering tester from Q-panel Company) on the film. The results of the test are shown in Table 1 below.

### Example 2

The procedure of Example 1 was repeated, with the exception that the substrate UX-150 (from Teijin) was replaced by the substrate E60L (Toray). The results of the test are shown in Table 1 below.

### Comparative Example 1

The substrate UX-150 (from Teijin) without the coating capable of absorbing UV light was directly subjected to the weathering test (utilizing the QUV weathering tester from Q-panel Company). The results of the test are shown in Table 1 below.

### Comparative Example 2

The procedure of Example 1 was repeated, with the exception that the substrate UX-150 (Teijin) was replaced by the substrate E60L (Toray). The results of the test are shown in Table 1 below.

Table 1: Yellowing Index (YI) Values Varying With the Exposure Time During the QUV Accelerated Weathering Test

(Test on the primary wavelength of 313 nm)

| | Exposure | Exposure | Exposure | Exposure | Exposure | Exposure |
|---|---|---|---|---|---|---|
| | 20 hr | 40 hr | 110 hr | 150 hr | 200 hr | 300 hr |
| | ΔYI | ΔYI | ΔYI | ΔYI | ΔYI | ΔYI |
| EXAMPLE 1 | 0.5 | 0.6 | 0.9 | 1.0 | 1.15 | 1.25 |
| EXAMPLE 2 | 0.7 | 1.2 | 1.7 | 2.1 | 2.5 | 2.8 |
| COMPARATIVE | 0.73 | 2.06 | 4.96 | 5.95 | 8.76 | 11.26 |
| EXAMPLE 1 | | | | | | |
| COMPARATIVE | 5.54 | 8.7 | 14.71 | 15.78 | 17.43 | 20.53 |
| EXAMPLE 2 | | | | | | |

Comparisons of the results of Example 1 with Comparative Example 1 and Example 2 with Comparative Example 2 reveal that the substrates with a coating capable of absorbing UV light on their surfaces exhibit a good resistance to yellowing, and thus possess a good UV light resistance.

What is claimed is:

1. An optical film comprising a substrate, characterized in that at least one of the surfaces of the substrate has a coating capable of absorbing UV light.

2. The optical film of claim 1, wherein the substrate comprises at least one layer of polymeric resin.

3. The optical film of claim 2, wherein the polymeric resin is selected from the group consisting of a polyester resin, a polyacrylate resin, a polyolefin resin, a polycarbonate resin, and a polyurethane resin and a mixture thereof.

4. The optical film of claim 1, wherein the coating capable of absorbing UV light contains inorganic particulates and a fluoro resin.

5. The optical film of claim 4, wherein the inorganic particulates are selected from the group consisting of zinc oxide, silicon dioxide, titanium dioxide, alumina, calcium sulfate, barium sulfate, calcium carbonate, and a mixture thereof.

6. The optical film of claim 4, wherein the size of the inorganic particulates is in the range of 1-100 nanometers.

7. The optical film of claim 4, wherein the fluoro resin comprises a copolymer of a fluoroolefin monomer and an alkyl vinyl ether monomer.

8. The optical film of claim 7, wherein the fluoroolefin monomer is selected from the group consisting of chloroethylene, vinylidene fluoride, trifluorochloroethylene, tetrafluorethylene, hexafluoropropylene and a mixture thereof.

9. The optical film of claim 7, wherein the alkyl vinyl ether monomer is selected from the group consisting of straight chain alkyl vinyl ether monomers, branched alkyl vinyl ether monomers, cyclic alkyl vinyl ether monomers, and hydroxyl alkyl vinyl ether monomers and a mixture thereof.

10. The optical film of claim 7, wherein the carbon number of the alkyl is from 2 to 11.

11. The optical film of claim 1, wherein the coating further comprises a curing agent.

12. The optical film of claim 1, wherein the coating further comprises a fluorescent agent or a UV light absorbent or a mixture thereof.

13. The optical film of claim 1, which is used as an anti-UV film on glasses.

14. The optical film of claim 1, which is used in LCDs as a UV-resistant reflective film for the back light source.
